(19) United States
(12) Patent Application Publication
(10) Pub. No.: US 2026/0116673 A1
(43) Pub. Date: Apr. 30, 2026

(54) SYSTEM AND METHOD FOR ALIGNING HATCHES WITH SPOUTS

(71) Applicants: Collin T. Turkelson, Charlevoix, MI (US); Reinhard Matye, Charlevoix, MI (US)

(72) Inventors: Collin T. Turkelson, Charlevoix, MI (US); Reinhard Matye, Charlevoix, MI (US)

(21) Appl. No.: 19/373,263

(22) Filed: Oct. 29, 2025

Related U.S. Application Data
(60) Provisional application No. 63/714,387, filed on Oct. 31, 2024.

(51) Int. Cl. B65G 47/28; B67D 7/32; G06T 11/00; H04N 7/18

(52) U.S. Cl. CPC B65G 47/28; B67D 7/3245; G06T 11/00; H04N 7/183; G06T 2200/24

(57) ABSTRACT

A system and method for aligning hatches of vehicles with spouts can provide enhanced feedback for drivers of the vehicles and operators of the spouts using real-time data mirroring techniques. The system provides driver and operator display interfaces to provide real-time feedback for both the drivers and the operators. Such feedback includes a real-time image feed showing a spout and a hatch in a loading bay area, along with graphical elements to further facilitate alignment of the spout and hatch. The feedback is provided on the operator display interface, and is automatically mirrored on the driver display interface in real-time without requiring separate configuration or initiation of the driver display interface. This allows spout operators to more efficiently communicate with vehicle drivers by eliminating the need to initiate separate requests or explicit indications to update both regions.

### CROSS REFERENCE TO RELATED APPLICATION

The present application claims the benefit of U.S. provisional application Ser. No. 63/714,387 filed Oct. 31, 2024, which is hereby incorporated herein by reference in its entirety.

### FIELD OF THE DISCLOSURE

The present disclosure relates to alignment systems and methods, and, more particularly, to aligning hatches with spouts.

### BACKGROUND

Liquids and flowable dry materials, such as gravel, ash, cement, coal, and chemicals, are often loaded and unloaded in bulk in a variety of industries, such as agriculture (e.g., grain elevators, fertilizer plants, feed mills), mining, construction, and chemical manufacturing industries. The materials may be loaded and/or unloaded in bulk via openings defined by hatches in equipment, such as vehicles (e.g., trucks, trains, boats). The vehicles may contain the materials in storage compartments of the vehicles for transportation. In some cases, loading spouts deliver the materials to the vehicles. The loading spouts may be in loading bays (also known as loading docks and loading zones) of buildings, such as warehouses, industrial buildings, and commercial buildings.

### SUMMARY

A system and method for aligning hatches of vehicles with spouts in loading bay areas improve the efficiency of the alignment process by enhancing feedback for drivers of the vehicles using real-time data mirroring techniques. The system includes a driver display interface to display the feedback for the drivers, and an operator display interface to control the feedback in real-time. In particular, the operator display interface provides a feedback region to display a real-time image feed (e.g., a real-time video feed) showing a spout and a hatch of a vehicle in a loading bay area. The system automatically mirrors the feedback region on the driver display interface in real-time so that the drivers and operators can both benefit from real-time feedback concurrently without requiring initiation of separate display processes. The operator display interface is usable to provide and modify one or more graphical elements on the feedback regions to facilitate aligning the hatch with the spout. For example, the graphical elements may include instructional messages for the drivers and/or an outline of a shape over the image feed that indicates a target position for the hatch to be aligned with the spout. Because the feedback regions are synchronized in real-time, any changes made to the operator feedback region, such as new messages, are mirrored on the driver feedback region in real-time, allowing operators of hatches to instantly communicate with drivers using the operator display interface.

In one example of the present disclosure, a system facilitates alignment of a hatch of equipment with a spout in a loading bay area. The system includes a memory and a controller coupled to the memory. The controller generates a driver display interface on a display screen viewable by a driver of the equipment in the loading bay area, and an operator display interface on a different display screen in a location remote from the driver display screen. The controller receives image feed information from a camera directed toward the spout. In response to the controller receiving an input via the operator display interface, the controller provides on both display interfaces a region including an image feed of the spout in real-time based on the image feed information, and provides an input control on the operator display interface that is manipulatable to provide a graphical element in the regions. In response to the controller receiving another input via the input control of the operator display interface, the controller provides on both display interfaces the graphical element on the region in real-time.

In another example, the controller receives the image feed information and provides the image feed on both display interfaces without buffering.

In yet another example, the controller operates on a first computing device associated with the operator display screen, and simultaneously generates first and second display information on the first computing device, renders the first display information on the first computing device to provide on the operator display interface the region and the input control, and transmits the second display information from the first computing device to a second computing device associated with the driver display screen to provide the region on the driver display interface.

In a further example, the controller creates a one-way communication session between the first and second computing devices to transmit the second display information from the first computing device to the second computing device.

In another example, the controller receives the image feed information in a compressed format, decompresses the image feed information in the compressed format, and generates the first and second display information based on the image feed information in a decompressed format.

In yet another example, the controller applies H.265 codec to decompress the image feed information in the compressed format.

In a further example, the graphical element includes a guide line indicating a target position for the hatch, and is displayed over the image feed in each of the regions of both display interfaces.

In another example, the graphical element has a message for the driver of the equipment, such as a message indicating to maneuver the equipment to align the hatch with the spout, that the hatch is aligned with the spout, that the loading of material from the spout to the hatch is to begin, or that the loading of material from the spout to the hatch has completed.

In yet another example, the controller provides the operator display interface with the region and the input control without requiring user access credentials, and the controller provides another input control upon receiving the user access credentials.

Thus, the system and method improve communication techniques during the process of aligning hatches of equipment with spouts to enhance both operational efficiency and safety. This is accomplished by the system automatically mirroring in real-time the operator display interface's feedback region on the driver display interface without requiring separate configuration or initiation of the driver display interface's feedback region. This allows any request to change the feedback regions, such as providing, removing, and/or customizing a graphical element, to automatically apply to both the operator and driver display interfaces. The operator display interface is thus usable to provide constant communications to the driver display interface without undue delay.

These and other objects, advantages, purposes, and features of this disclosure will become apparent upon review of the following specification in conjunction with the drawings.

### BRIEF DESCRIPTION OF DRAWINGS

FIG. 1 is a side elevation view of a display screen, spout assembly, and vehicle in a loading bay area, the display screen viewable by a driver of the vehicle;

FIG. 2 is a rear elevation view of the driver display screen, spout assembly, and vehicle of FIG. 1, further showing a camera in the loading bay area;

FIG. 3 is a rear elevation view of the spout assembly and camera of FIG. 2;

FIG. 4 is a schematic of the driver display screen and camera of FIG. 2;

FIG. 5 is a schematic of another display screen viewable by an operator of the spout assembly of FIG. 1;

FIG. 6 is an exemplary page or form provided on a display interface displayable by the operator display screen of FIG. 5, the form showing an image feed of the loading bay area of FIG. 1;

FIG. 7 is another exemplary form provided on another display interface displayable by the driver display screen of FIGS. 1, 2, and 4, the form showing the image feed of FIG. 6;

FIG. 8 is another exemplary form provided on the operator display interface of FIG. 6, the form showing the image feed of FIG. 6;

FIG. 9 is another exemplary form provided on the operator display interface of FIG. 6, usable to launch the forms of FIGS. 6 and 7;

FIG. 10 is a block diagram of elements that are populated on the display interfaces of FIGS. 6-9; and

FIG. 11 is a flowchart of a process for updating a feedback region of the display interfaces of FIGS. 6-8.

### DETAILED DESCRIPTION

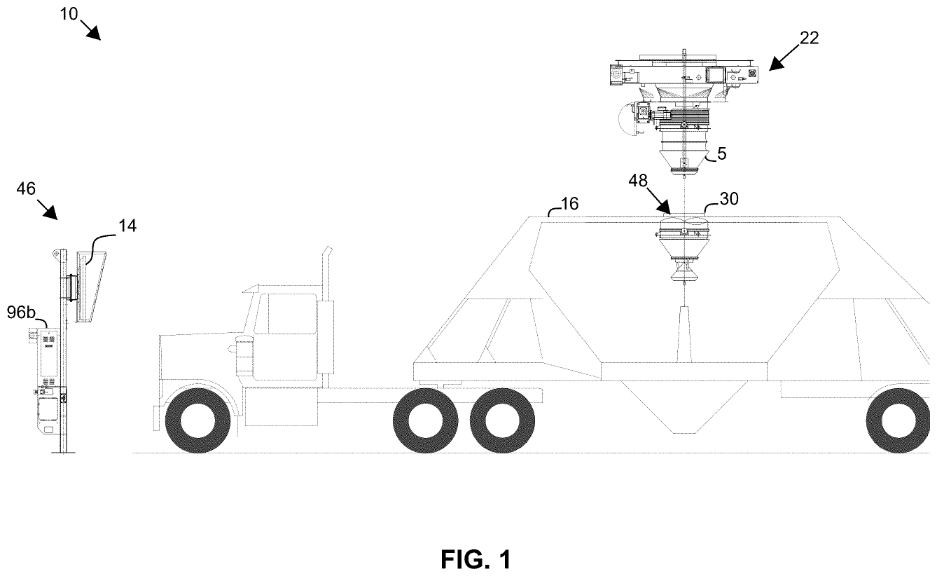

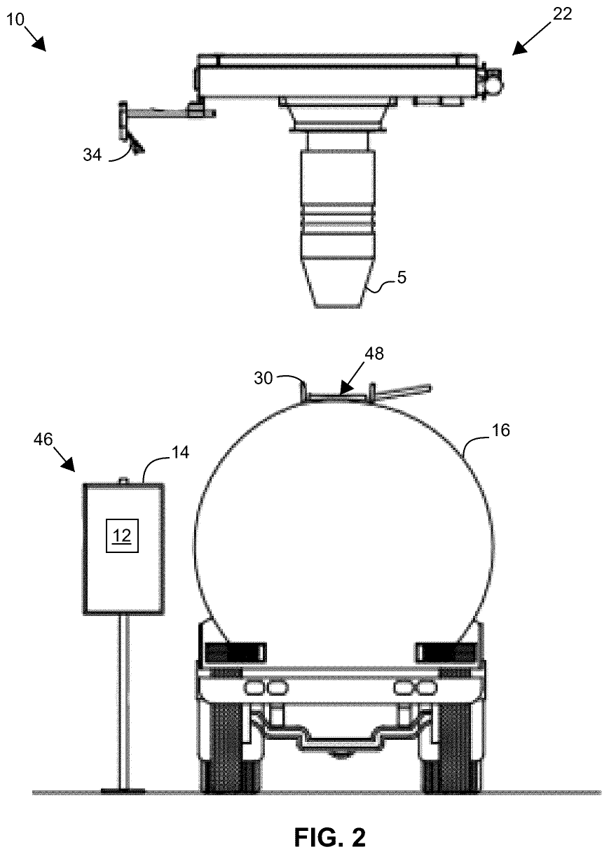

Referring now to the drawings and illustrative examples depicted therein, a system provides real-time feedback communication to facilitate readying equipment for loading and/or unloading of materials, including aligning a hatch 30 of a vehicle 16 with a spout 5 in a loading bay area 10. (FIGS. 1, 2). The system facilitates overcoming challenges or difficulties associated with using high latency videos or image feeds for feedback during the alignment process. Such high latency videos can result in an impaired perception of where spout 5 is located relative to hatch 30 of vehicle 16, which may prevent an operator of spout 5 from communicating timely messages to a driver of vehicle 16, negatively impact the driver's ability to accurately align and position vehicle 16, and delay the operator's ability to determine whether hatch 30 is aligned with spout 5. This impaired perception decreases operational efficiency, and may lead to spillage, misalignment, and the like. The system improves the efficiency and speed in which communications from the operator of spout 5 can be provided to the driver of vehicle 16 in loading bay area 10, promoting safer and more streamlined operation of loading materials from spout 5 and into vehicle 16.

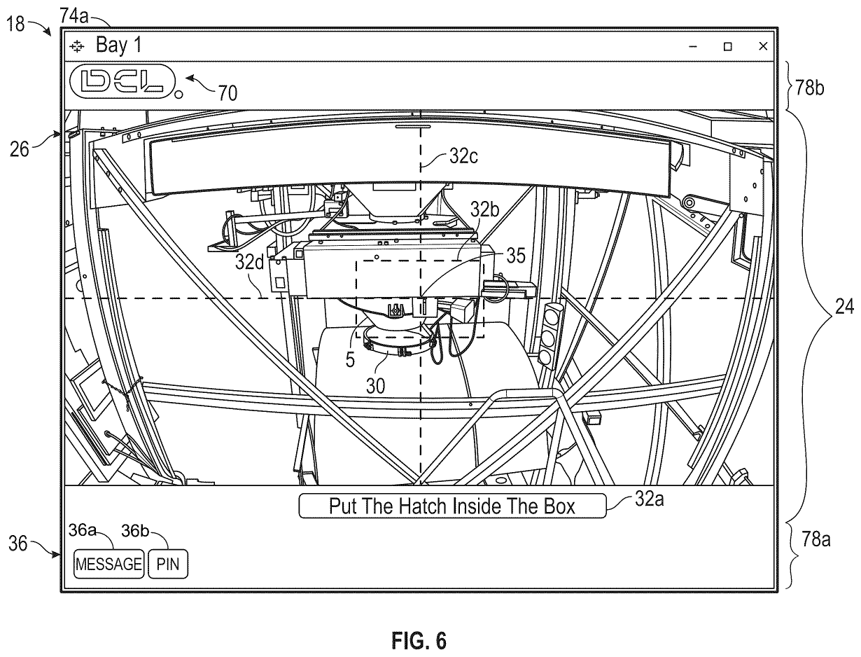

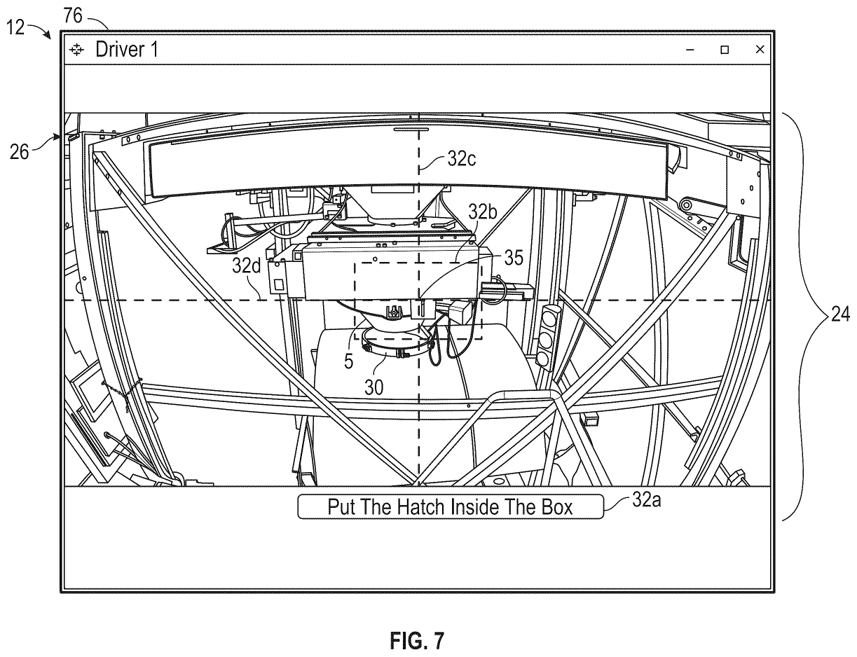

The system generates a display interface 12 on a display screen 14 viewable by the driver, and generates a different display interface 18 on another display screen 20 viewable by the operator. (FIGS. 2, 4-8). Driver and operator display interfaces 12, 18 include respective regions 24 that are synchronous with one another to provide real-time feedback for the driver and operator concurrently. (FIGS. 6-8). Regions 24 include a real-time image feed 26 (e.g., a video feed) of spout 5 of a spout assembly 22 and a hatch 30 of vehicle 16, along with modifiable graphical elements, such as an instructional message 32a for the driver to facilitate aligning its hatch 30 with spout 5. The system automatically mirrors feedback region 24 of operator display interface 18 on driver display interface 12 in real-time such that feedback regions 24 on display interfaces 12, 18 launch and update simultaneously. Operator display interface 18 is a user interface, and an update to feedback regions 24 can be requested via a single form or page of operator user interface 18, without requiring separate requests or explicit indications that the update is to be performed on both regions 24. This facilitates the speed in which communications from the operator can be provided to drivers via driver display interface 12 on driver display screen 14.

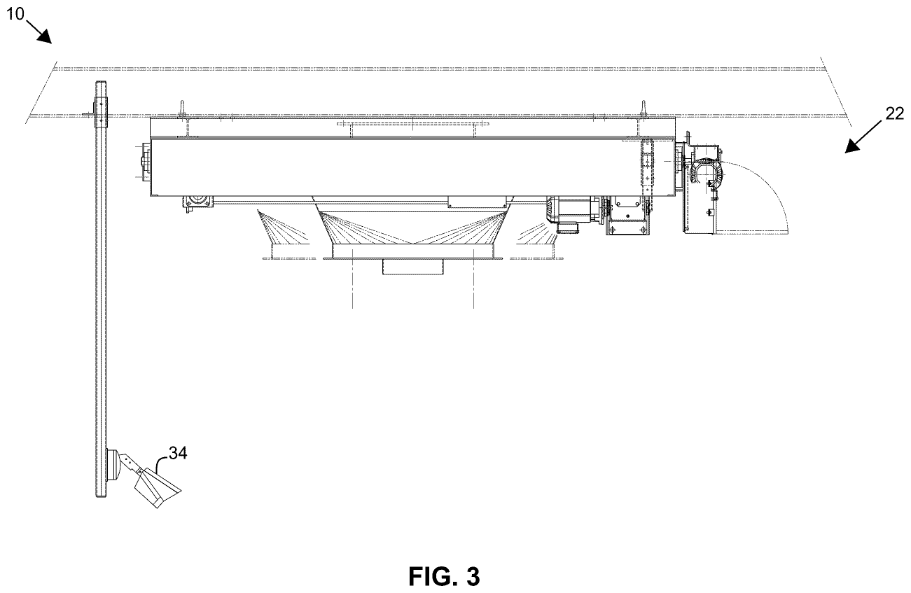

Feedback regions 24 each include image feed 26 in real-time based on image feed information captured by a camera 34 in loading bay area 10. (FIGS. 2-4, 6-8). This may be accomplished without performing any buffering processes to further ensure image feed 26 is provided on display screens 14, 20 in real-time. As shown in FIG. 2, camera 34 is directed downward and toward hatch 30 so that camera 34 can capture the image feed information of spout 5 and hatch 30, and image feed 26 can thus show spout 5 and hatch 30.

Feedback regions 24 each include graphical elements to facilitate the operator with determining whether hatch 30 is aligned with spout 5, and facilitate the driver with maneuvering vehicle 16 to align hatch 30 with spout 5. (FIGS. 6-8). As used herein, the term “aligned” refers to any desired positional relationship between hatch 30 and spout 5 to begin the loading process, such as hatch 30 being positioned in an area where spout 5 can move to a suitable position for delivering material to hatch 30. Such area may be referred to as a “reach zone”.

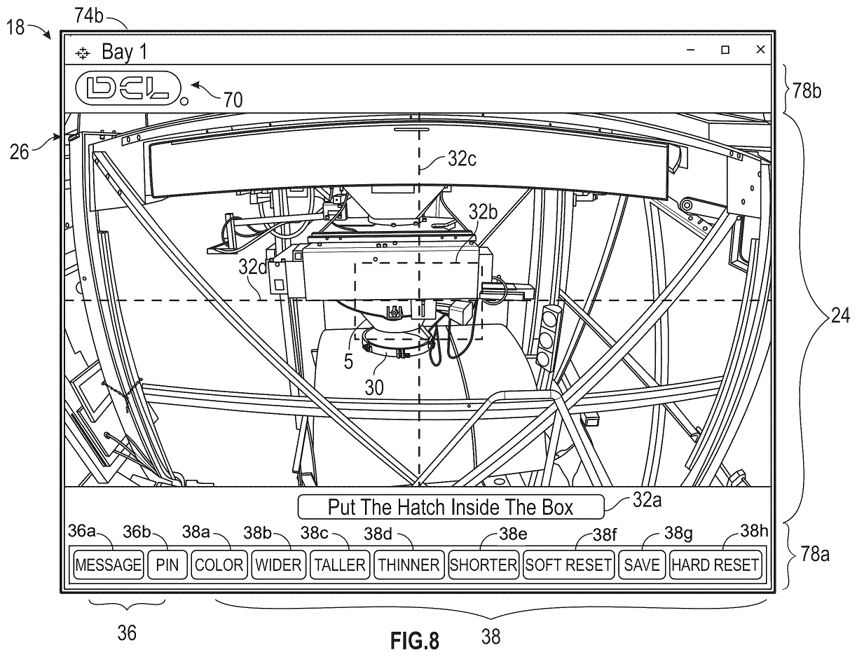

Operator display interface 18 provides graphical user interface (GUI) input controls 36 manipulatable to provide and/or modify graphical elements on feedback regions 24. (FIG. 6). Operator display interface 18 prevents some features of the graphical elements from being modified, unless user access credentials are provided via operator display interface 18. (FIG. 6). This further ensures safety in loading bay area 10 as unauthorized users are prevented from interfering with the alignment process. After operator display interface 18 receives user access credentials, operator display interface 18 provides additional GUI controls 38 manipulatable to modify additional features of the graphical elements on feedback regions 24. (FIG. 8).

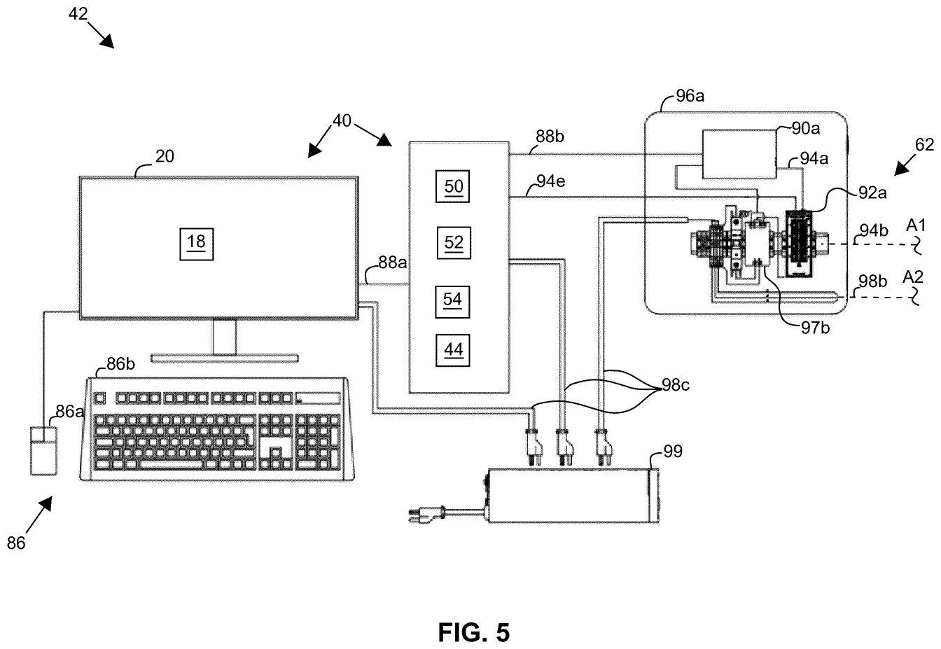

Operator display interface 18 is provided on operator display screen 20 of a computing device 40 in a location remote from driver display screen 14, such as in a control area 42. (FIG. 5). For example, loading bay area 10 may be located in an environment such as a building (e.g., a warehouse), and control area 42 may be located elsewhere in the building. (FIGS. 1-5). Operator display interface 18 can thus be used by the operator to monitor loading bay area 10 and communicate to the driver of vehicle 16 while away from loading bay area 10.

Thus, display interfaces 12, 18 enhance communication during the alignment of hatch 30 and spout 5, improving both operational efficiency and safety. This is achieved by automatically mirroring in real-time feedback region 24 of operator display interface 18 on driver display interface 12, without requiring separate configuration of driver display interface 12. Any changes requested via operator display interface 18, such as changes to graphical elements and instructional messages for the driver, are thus automatically applied to both regions 24. As a result, both display interfaces 12, 18 can continuously provide feedback of loading bay area 10 without undue delay.

Referring to FIG. 5, operator computing device 40 includes a controller 44 that obtains the image feed information from camera 34. For example, camera 34 captures a plurality of images (e.g., frames) to provide the image feed information to controller 44 in the form of an image stream (e.g., video stream).

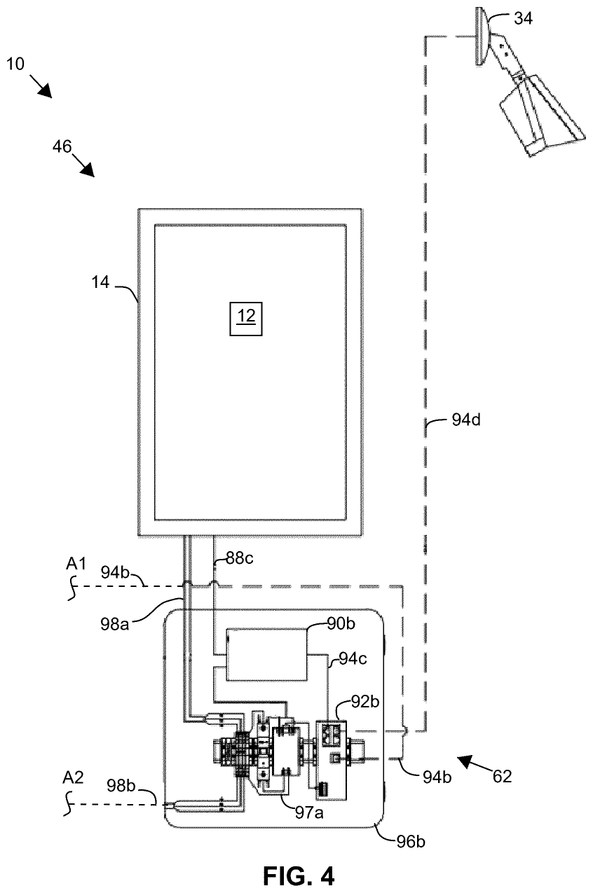

Controller 44 simultaneously generates first and second display information based on the image feed information to generate respective feedback regions 24 on driver and operator display interfaces 12, 18 for displaying image feed 26 in real-time. (FIGS. 5-8). The image feed information from camera 34 may be in a compressed format encoded by H.265 codec (also known as high efficiency coding (HEVC)), and controller 44 may decode or decompress the encoded image feed information by using H.265 codec before further processing, such as applying any graphical elements over the image feed information. (FIGS. 4, 5). Controller 44 processes the image feed information to generate the first and second display information in a way that ensures image feed 26 is in real-time, such as by removing audio, not performing buffering processes, not applying delay caching, and/or not applying audio or video synchronization. (FIGS. 5-8).

Controller 44 further generates first and second display information based on graphical element information indicating any graphical elements to be included in feedback regions 24. (FIG. 5). For example, the graphical element information may indicate to generate: (i) a box guide line 32b over image stream 26 that provides a box-shaped outline defining a target region for hatch 30, (ii) a message 32a that displays “Put The Hatch Inside The Box”, (iii) a vertical guide line 32c over image feed 26, and (iv) a horizontal guide line 32d intersecting with vertical line 32c at an intersection point 35, such as at the center of box shape 32b to indicate that the center of opening 48 of hatch 30 should be positioned at the intersection point 35 to be aligned with spout 5. (FIGS. 6-8). Graphical elements 32a-d may be image overlays.

Controller 44 further generates first display information based on GUI input control information. For example, the GUI input control information may indicate to generate GUI input controls 36 including a message icon 36a selectable to create a message, and a pin icon 36b selectable to access additional GUI controls 38. (FIG. 6). In another example, the GUI input control information may indicate to generate GUI input controls 36 and additional GUI input controls 38, such as after the operator provides user access credentials, including: (i) a color icon 38a selectable to modify color, size, and/or style of guide lines 32b-d, (ii) a wider icon 38b selectable to modify box shape 32b to have a greater width, (iii) a taller icon 38c selectable to increase height of box shape 32b, (iv) a thinner icon 38d selectable to decrease width of box shape 32b, (v) a shorter icon 38e selectable to decrease height of box shape 32b, (vi) a save icon 38f selectable to update the display settings, (vii) a soft reset 38g selectable to remove the changes made since the last save, (viii) a hard reset 38h selectable to restore guide lines 32b-d to the original default display settings. (FIG. 8). For example, icons 38b-e may be selected by the operator to cause box shape 32b to have dimensions corresponding to a reach zone of spout 5 such that hatch 30 in the reach zone can receive materials from spout 5.

The GUI input control and graphical element information used by controller 44 to generate the display information may be based on display settings stored in a memory 50 that includes one or more non-transitory computer-readable mediums, such as non-volatile memory(s) (e.g., flash memory, hard disk drive, solid-state drive, read-only memory) and/or volatile memory(s) (e.g., random access memory (RAM), synchronous dynamic RAM, dynamic RAM, cache memory). The display settings may be customizable to define default graphical element information, such as information indicating to provide box guide line 32b over image stream 26. The display settings may also be customizable to define restricted GUI input control information (e.g., without user access credentials), such as information indicating to provide GUI input controls 36, and default full-access GUI input control information (e.g., with user access credentials), such as information indicating to provide GUI input controls 36, 38.

Operator computing device 40 renders the first display information to provide feedback region 24 on operator display interface 18 (FIG. 5), and transmits the second display information to a driver computing device 46 having driver display 14 to provide feedback region 24 on driver display interface 12 (FIGS. 1, 2, 4). Operator computing device 40 creates a one-way communication session with driver computing device 46 to transmit the second display information. (FIGS. 4, 5).

As shown in FIGS. 6-8, feedback regions 24 include image feed 26 and graphical elements 32a-d. Guide lines 32b-d provide visual references for the operator to determine whether hatch 30 is aligned with spout 5 such that the operator can safely initiate the loading process of assembly 22. For example, hatch 30 may be aligned with spout 5 when hatch 30 is located within box shape 32b, and center of opening 48 defined by hatch 30 is at intersection point 35. Guide lines 32b-d are similarly referenced by the driver to align hatch 30 with spout 5, and message 32a indicates how to align hatch 30 with spout 5.

As shown in FIG. 6, operator computing device 40 further renders the first display information to provide GUI controls 36 on operator display interface 18 when controller 44 has not received user access credentials. Alternatively, as shown in FIG. 8, operator computing device 40 renders the first display information to provide GUI controls 36, 38 on operator display interface 18 when controller 44 has received and verified user access credentials.

Controller 44 may store and/or produce retention information based on the image feed information from camera 34 and/or the display information produced by controller 44. (FIG. 5). The retention information may be stored so that if an error occurs during loading (e.g., a spillage of material from spout 5), the operator can retrieve the retention information and assess what caused the error, who was at fault, how to troubleshoot, and the like. The retention information may be stored in a variety of formats, such as a compressed or uncompressed format.

Controller 44 may store the retention information while simultaneously generating display information so that driver display screen 14 and operator display screen 20 can continue to display image stream 26 in real-time. (FIG. 5). This may be accomplished by using a multimedia framework, such as GStreamer. Controller 44 may store the retention information in memory 50.

Memory 50 may store storage settings that indicate how to store the retention information. (FIG. 5). For example, the storage settings may define that the retention information should be stored on a rolling basis, such as for a specified time (e.g., a week, a month). Controller 44 may then automatically overwrite the retention information after it has been stored for the specified time with new retention information that is provided by controller 44.

Controller 44 may also generate and/or store batches of analytic information for each vehicle that enters bay area 10 for loading and/or unloading. (FIG. 5). The batches of analytic information may relate to loading times, alignment accuracy, patterns of spout 5 usage, and/or any other relevant metrics. For example, a batch of analytic information may be stored in memory 50 that relates to the vehicle 16 receiving material from spout 5, such as: (i) an amount of time it took to load material from spout 5 to the vehicle 16 via hatch 30, (ii) an indication of whether the alignment of hatch 30 and spout 5 was accurate, and/or (iii) a quantity of the material loaded from spout 5 to the vehicle 16 via hatch 30.

Controller 44 may use the batches of analytic information to generate reports, determine when maintenance should be performed, identify hindrances in the alignment and/or the loading processes, and/or improve the efficiency of the alignment and/or loading processes. (FIG. 5). For example, controller 44 may monitor whether maintenance should be performed on spout 5 and/or another part of spout assembly 22 based on the analytic information indicating the amounts of material delivered by spout 5. Controller 44 may determine that maintenance should be performed on spout assembly 22 when the total of the amounts of material delivered by spout 5 meet or exceed the recommended maintenance amount, which may be provided by the manufacturer's instruction for use of spout assembly 22. In response to controller 44 determining that maintenance should be performed on spout 5, controller 44 may provide a notification to the operator via operator display interface 18. This regular maintenance may prevent costly breakdowns and/or improve the lifespan of spout assembly 22.

Controller 44 may use an artificial intelligence (AI) model 52 to generate reports, determine when maintenance should be performed on spout assembly 22, identify hindrances in the alignment and/or the loading processes, improve the efficiency of the alignment and/or loading processes, and the like. (FIG. 5). AI model 52 may include one or more algorithms that have machine learning, deep learning, and/or other artificial machine-driven logic. AI model 52 may be trained with historical information (e.g., batches of analytic information) to recognize patterns and/or associations and follow such patterns and/or associations when processing a new input (e.g., a new batch of analytic information) such that other inputs result in outputs consistent with the recognized patterns and/or associations. AI model 52 can be updated or re-trained based on inputs such as, for example, one or more batches of analytic information and/or characteristic information relating to the outputs provided AI model 52. AI model 52 may be operable to select an optimum solution for a given input based on the one or more trained algorithms.

Controller 44 may use AI model 52 to recommend a preventative maintenance schedule for when maintenance should be performed on spout assembly 22. For example, controller 44 may provide the trained AI model 52 with a new batch of analytic information, and AI model 52 may provide an output indicating whether spout assembly 22, such as spout 5, is due for maintenance. AI model 52 may be updated based on characteristic information of spout assembly 22 that indicates the performance quality of spout assembly 22 (e.g., whether spout assembly 22 has broken down) and/or the structure quality of spout assembly 22 (e.g., whether the parts have deteriorated).

Controller 44 executes an application 54 to accomplish any of the processes described herein. Application 54 may include a computer application (e.g., a macOS application, a Linux application, Windows application) and/or a server-side application accessible using a web browser (e.g., Microsoft Internet Explorer, Mozilla Firefox, Google Chrome, Apple Safari, Opera).

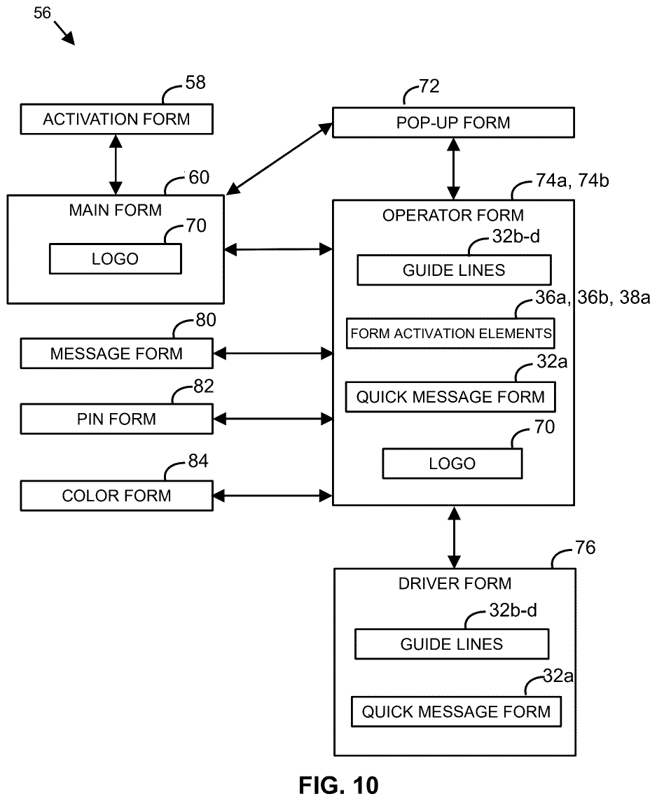

Referring to FIG. 10, application 54 has a structure 56 of elements, such as pages or forms or screens, that are populated on driver and operator display interfaces 12, 18. The operator may transition between the different forms as a navigation flow of application 54 based on structure 56. For example, application 54 first launches an activation form 58 on operator display interface 18 before any of the other forms so that the operator can enter a code to access application 54. (FIG. 10). Activation form 58 may use a secondary application to generate the code by encrypting machine code.

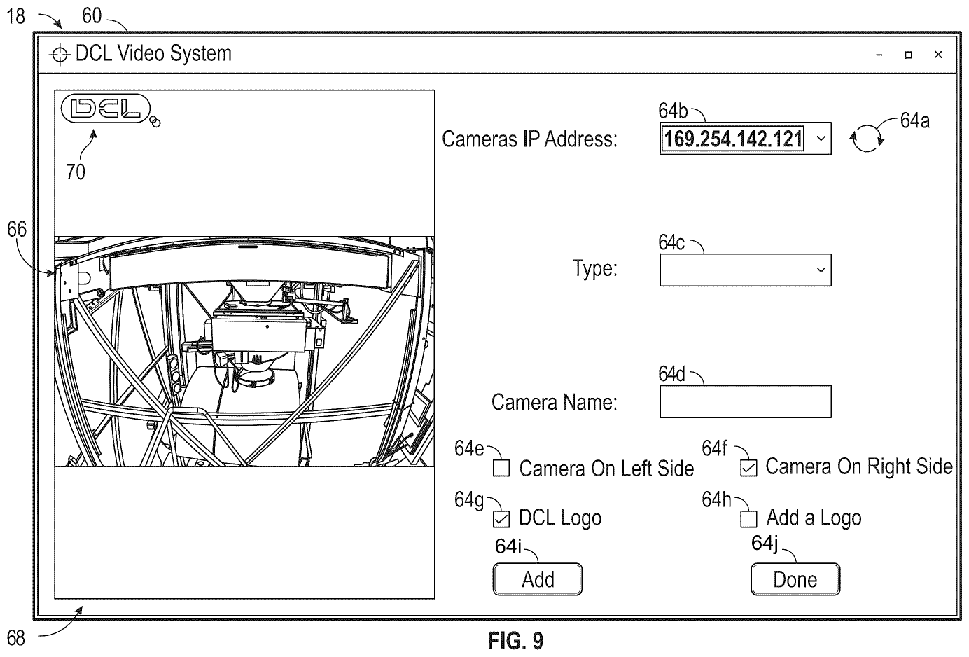

Referring to FIGS. 9 and 10, after application 54 verifies that the code received via activation form 58 is valid, application 54 provides a main form 60 on operator display interface 18 to set up a connection between application 54 of controller 44 and camera 34 so that controller 44 can receive image feed information from camera 34. In some examples, camera 34 is an internet protocol (IP) camera that can connect to controller 44 over a network 62 having one or more networks, such as local area network(s) (LAN(s)), wide area network(s), cellular network(s) (also known as mobile networks), intranet network(s), extranet network(s), and/or Internet network(s). Controller 44 can detect and connect with IP camera 34 by scanning network 62. For example, IP camera 34 has an IP address, such as a Real Time Streaming Protocol (RTSP) Uniform Resource Locator (URL), that is discoverable via network 62.

Main form 60 has a scan icon 64a selectable to detect and connect with camera 34. Upon selection of scan icon 64a, controller 44 scans network 62 for any IP devices connected to network 62, such as a LAN. In some examples, controller 44 scans network 62 for only IP devices compliant with an Open Network Video Interface Forum (ONVIF) standard. Main form 60 has a drop-down menu 64b that lists any IP addresses associated with the IP devices that were discovered during the scan of network 62. The IP addresses are selectable to establish connections between controller 44 and the respective IP devices. As such, if controller 44 discovers camera 34 during the scan of network 62, the IP address associated with camera 34 should be listed in drop-down menu 64b and selectable by the operator to establish the connection between controller 44 and camera 34.

After a connection is established between controller 44 and camera 34, controller 44 can receive image feed information from camera 34. Application 54 then provides on main form 60 an image feed 66 in image region 68 of main form 60.

Main form 60 can receive other information relating to camera 34. (FIG. 9). For example, main form 60 includes: (i) a drop-down menu 64c that lists types of devices selectable to specify the type of camera 34, (ii) a text field 64d where text can be entered to identify camera 34 by a name, (iii) a checkbox button 64e selectable to indicate that camera 34 is on the left side, (iv) a checkbox button 64f selectable to indicate that camera 34 is on the right side (as shown in FIG. 9), (v) a checkbox button 64g selectable to provide an uploaded logo 70 (e.g., a DCL® logo as shown in FIG. 9), and (vi) a checkbox button 64h selectable to add a new logo.

If the IP address of camera 34 does not appear in drop-down menu 64b, the operator may select scan icon 64a to initiate another scan of network 62. (FIG. 9). If drop-down menu 64b continues to not provide an IP address associated with camera 34, application 54 may populate operator display interface 18 with a pop-up form 72 to provide a procedure to troubleshoot the connection problem. (FIG. 10). Pop-up form 72 may also be provided on operator display interface 18 when controller 44 loses connection with camera 34.

Main form 60 has a done icon 64i selectable to save information relating to camera 34 and/or display settings. (FIG. 8). In response to selection of done icon 64i, application 54 launches an operator form 74a on operator display interface 18 based on information input into main form 60, and driver form 76 on driver display interface 12 based on operator form 74a. Both forms 74a, 76 are launched in response to the single selection of done icon 64i without requiring any further inputs to launch driver form 76. Application 54 renders operator and driver forms 74a, 76, including respective feedback regions 24 synchronous with one another, without requiring another instance of the application 54.

Application 54 provides real-time image feeds 26 displayed in feedback regions 24, even when network 62 in which camera 34 is communicating to controller 44 has limited bandwidth. This may be accomplished by application 54 using one or more frameworks to process the image feed information from camera 34, such as a software development framework (e.g., .NET framework), a multimedia framework (e.g., GStreamer), and/or the like. For example, application 54 uses a framework, such as GStreamer, to instantiate a pipeline for processing the image feed information from camera 34 for generating both image feeds 26, without two separate pipelines for each image feed 26. The framework may use one or more codecs, such as H.265 or HEVC video compression standard, to facilitate application 54 in generating image feed 26 in high resolution and real-time. However, any other suitable codec may be used, such as H.264 codec (also known as Advanced Video Coding (AVC)), VP9, AOMedia Video 1 (AV1) codec, and the like. Application 54 and the framework may communicate with one another using one or more computer-readable instructions (e.g., algorithms) represented in any desired language (e.g., C language, C#language, common language infrastructure (CLI) language). For example, application 54 may have a .NET framework that uses C#language and CLI language to communicate with GStreamer, which may be written in C language, to process the image feed information.

FIG. 6 shows GUI controls 36 that allow the operator to control both feedback regions 24 using just the single operator form 74a. Operator form 74a includes GUI controls 36 in a lower bar region 78a to control feedback regions 24, and logo 70 in upper bar region 78b. Bar regions 78a, 78b may preserve the original aspect ratio of image feed information captured on camera 34.

GUI controls 36 include message icon or send message form 36a selectable to launch a message form 80. (FIGS. 6, 10). Message form 80 is usable to replace message 32a with a new message while guide lines 32b-d remain unchanged. For example, the new message can provide any prompt for the driver, such as an instruction to assist with aligning hatch 30 with spout 5, an instruction to maneuver vehicle 16, a notification that hatch 30 is aligned, an instruction to open a lid of hatch 30, a notification that the loading process will begin, a notification that the loading process is complete, and/or a notification that the driver can exit bay area 10.

Message form 80 may have: (i) one or more button selectable icons corresponding to preset messages in any language (e.g., English, Spanish, Hindi), (ii) a text field manipulatable to enter a custom message, (iii) one or more button selectable icons corresponding to preset times indicating the time duration for the new message to appear on feedback regions 24, (iv) a text field manipulatable to enter a custom time indicating the time duration for indicating the time duration for the new message, and/or (v) a save button selectable to initiate the change of feedback regions 24. In some cases, there may be a default time to display the new message (e.g., thirty seconds) on feedback regions 24. After the set time for the new message has elapsed, the new message may be automatically removed from feedback regions 24.

GUI controls 36 also include pin icon 36b selectable to launch a pin form 82 (FIGS. 6, 10). Pin form 82 is usable to enter and submit a pin or password into a text field of the pin form 82. If application 54 determines that the pin submitted is valid, application 54 generates a modified operator form 74b the same as other operator form 74a but including additional GUI controls 38 for controlling feedback regions 24. (FIG. 8). GUI controls 38 include color icon 38a selectable to launch a color form 84 on operator display interface 18 that is usable to modify the color, size, and/or style of guide lines 32b-d. (FIGS. 8, 9). Other icons 38b-h are selectable to perform operations discussed above without requiring additional forms to be launched.

Many other visual references are contemplated. For example, guide lines 32b-d may be replaced with two vertical lines extending through the entire feedback region 24. The two vertical lines may be spaced apart so that the width between the vertical lines corresponds to the width of the reach zone of spout 5. In another example, guide line 32b may be any other shape, such a circle, a square, and the like. In yet another example, vertical and horizontal guide line 32c, 32d may be omitted. In still a further example, guide lines 32b-d and/or the message 32a may be transparent.

Many other views or forms on display interfaces 12, 18 are also contemplated. For example, the views may show any suitable configuration and/or combination of region(s), graphical element(s), guide line(s), GUI control(s), and/or message(s).

As illustrated in the examples herein, operator computing device 40 is a desktop computer, and operator display screen 20 is a computer monitor. (FIG. 5). Computing device 40 has input controls 86, including a mouse 86a and a keyboard 86b, usable to interact with operator display interface 18 for providing inputs to controller 44. Operator computing device 40 may include a computer case or tower having controller 44. However, the operator computing device 40 may be implemented by any other suitable computing device, such as a smartphone, a laptop computer, a tablet computer, and the like.

Controller 44 may be implemented as hardware, software, firmware, and/or any combination of hardware, software, and/or firmware. (FIG. 5). Controller 44 may be implemented as one or more devices, such as programmable processor(s) (e.g., a field programmable gate array, a programmable logic controller), microprocessor(s) (e.g., a multi-core processor, a crypto processor, a digital signal processor, a graphics processing unit), microcomputer(s) (e.g., an electronic control unit), microcontroller(s), central processing unit(s), state machine(s), and/or circuit(s) (e.g., an analog circuit, a logic circuit, a crypto circuit, an application specific integrated circuit).

Driver computing device 46 is a television, and driver display screen 14 is a television screen. (FIGS. 1, 2, 4). However, driver computing device 46 may be implemented by any other suitable computing device, such as a projector system. Further, driver display screen 14 and/or operator display screen 20 may be implemented as any other suitable display device. For example, display screens 14, 20 may be implemented as one or more devices, such as touchscreen(s), light-emitting diode(s) (LED(s)), liquid crystal display(s), organic LED(s), cathode ray tube(s), mini-LED(s), micro-LED(s), projected display(s), and/or the like.

Operator display screen 20, driver display screen 14, and camera 34 are in communication with controller 44 via one or more wired and/or wireless communication links, such as High Definition Multimedia Interface(s) (HDMI(s)), Universal Serial Bus(es) (USB(s)), Digital Visual Interface(s), DisplayPort(s), Video Graphics Array(s), and/or network 62. (FIGS. 4, 5).

Referring to FIGS. 4 and 5, controller 44 provides first display information to operator display screen 20 via a first HDMI cable 88a. Controller 44 transmits second display information to driver display screen 14 by first transmitting second display information to a HDMI transmitter 90a via a second HDMI cable 88b. (FIG. 5). HDMI transmitter 90a may encode the second display information into a format suitable for transmission over a network 62, and then provide the encoded second display information to a switch 92a of network 62 via an ethernet cable 94a of network 62. For example, the second display information may be encoded by compressing the second display information using a codec (e.g., H.265). Switch 92a and HDMI transmitter 90a are within a junction box 96a positioned in or near control area 42.

Control area switch 92a of junction box 96a provides the encoded second display information to another switch 92b of network 62 within another junction box 96b that is positioned in or near bay area 10. (FIGS. 4, 5). Bay switch 92b receives the encoded second display information from control area switch 92a via another ethernet cable 94b (e.g., Cat6 ethernet cable) of network 62. Ethernet cable 94b has a break line A1 shown in FIG. 4 to indicate that it continues to the break line A1 shown in FIG. 5.

Bay switch 92b provides the encoded second display information to a HDMI receiver 90b in bay junction box 96b via another ethernet cable 94c. (FIG. 4). HDMI receiver 90b decodes the encoded second display information, and then provides the second display information to driver display screen 14 via an HDMI cable 88c. Driver display screen 14 can then display driver form 67 showing image stream 26 based on second display information.

IP camera 34 communicates the image feed information to controller 44 via network 62. (FIGS. 4, 5). Camera 34 encodes the image feed information into a format suitable for transmission over a network 62. For example, camera 34 encodes the image feed information by using a codec (e.g., H.265). Camera 34 provides bay switch 92b with the encoded image feed information via another ethernet cable 94d (e.g., Cat6 power over ethernet cable), and bay switch 92b then provides the encoded image feed information to control area switch 92a via ethernet cable 94b. Control area switch 92a provides controller 44 with the encoded image feed information via another ethernet cable 94e.

Bay switch 92b may be a power over ethernet (POE) switch, and ethernet cable 94d between bay switch 92b and camera 34 may be a POE cable (e.g., a Cat6 POE cable) so that camera 34 can be powered by bay switch 92b. (FIG. 4). Bay switch 92b and HDMI receiver 90b receive power from a power supply 97a in bay junction box 96b via one or more power cables. Bay power supply 97a also provides power to driver display screen 14 via a power cable 98a. Bay power supply 97a receives power from a power supply 97b in control area junction box 96a via a power cable 98b that has a break line A2 shown in FIG. 4 to indicate that the power cable 98b continues to the break line A2 shown in FIG. 5.

Control area power supply 97b provides power to control area switch 92a and HDMI transmitter 90a via one or more power cables in control area junction box 96a. Control area power supply 97b, controller 44, operator display screen 20, and/or the input controls 86 may be powered by a battery 99 via power cables 98c. Battery 99 may receive power from an external power source connector (e.g., an outlet of a utility grid power source). Any suitable power supply may be supplied via the power cables such as, for example, a 120 volt alternating current (AC) power supply.

Junction boxes 96a, 96b may have multiple terminals to connect the power cables, the ethernet cables, the HDMI cables, and the like. (FIGS. 4, 5). Junction boxes 96a, 96b may further include one or more power or circuit breakers.

In some cases, the environment of loading bay area 10 and control area 42 has additional bay areas similar to loading bay area 10 shown in FIGS. 1-4. Control area switch 92a may be a managed switch that can provide image inputs (image feed information) from the multiple cameras to controller 44. (FIG. 5). Controller 44 may thus generate operator and driver display interfaces for other bay areas.

While examples of the system are shown in FIGS. 1-10, one or more of the elements illustrated in FIGS. 1-10 may be combined, divided, re-arranged, omitted, and/or implemented in any other way. For example, controller 44 may be implemented by one or more computing devices in addition to or instead of the operator computing device 40 such as, for example, driver computing device 46, desktop computer(s), laptop computer(s), tablet computer(s), hardware server(s), cloud-based server(s), web server(s), application server(s), proxy server(s), and/or network server(s). In another example, controller 44 may be distributed across computing devices at one or more different network locations (e.g., a peer-to-peer network environment, a client-server network environment).

Further, the system of FIGS. 1-10 may include one or more elements in addition to and/or instead of the elements shown in FIGS. 1-10, and/or may include more than one of the elements shown in FIGS. 1-10. For example, bay area 10 may have more than one camera and/or control area 42 may have more than one operator display screen. In another example, another computing device outside of the environment may communicate with controller 44 remotely over a network (e.g., the Internet), such as to trigger application 54 to store retention information in memory 50, adjust a setting of camera 34, modify one or more graphical elements (e.g., guide lines 32b-d, the message 32), and the like. In another example, bay area 10 may have one or more output devices in addition to driver display screen 14, such as a speaker that provides audible feedback for the driver of the vehicle 16.

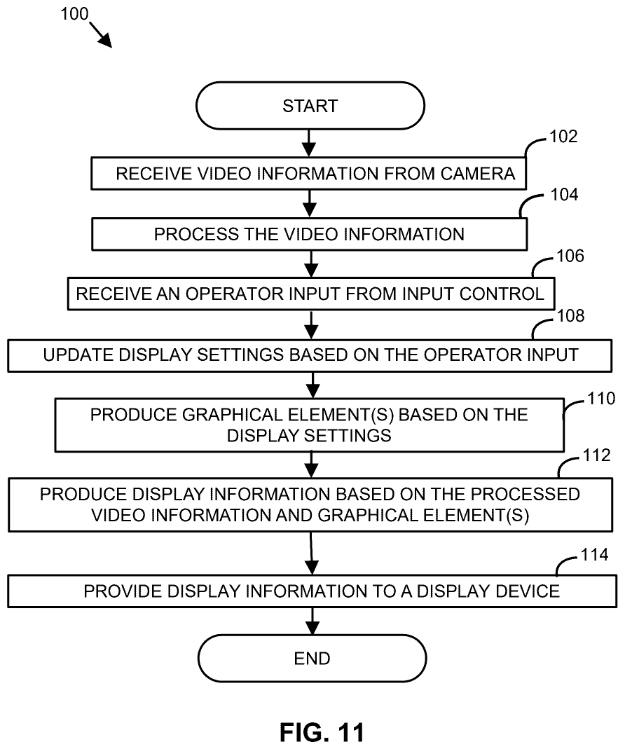

FIG. 11 is a flowchart of a process 100 for updating feedback region 24 of FIGS. 6-8. The process 100 may be implemented as hardware logic, computer-readable instructions, hardware implemented state machines, and/or any combination thereof. For example, process 100 can be implemented by the system of FIGS. 1-10, and process 100 is described with reference to such system for exemplary purposes.

At block 102, the process 100 begins when application 54 receives video or image feed information from camera 34. The video information may be provided in a compressed format (e.g., compressed using H.265 codec). At block 104, application 54 may process the video information. For example, if the video information was provided in a compressed format, controller 44 may decode the received video information. Controller 44 may also remove the sound from the video information.

At block 106, application 54 receives an operator input from one of the input controls 86. For example, the operator input may indicate to omit or change graphical elements 32a-d of feedback region 24. At block 108, application 54 updates display settings based on the operator input. For example, the display settings may be updated to indicate that controller 44 should produce display information that will cause feedback region 24 to be without one or more of graphical elements 32a-d, or with different graphical elements 32a-d. Such graphical element information or display settings may be stored in memory 50.

At block 110, application 54 produces one or more graphical elements based on the display settings. For example, application 54 may produce a graphical element (e.g., guide lines 32b-d) by retrieving the graphical element from memory 50. In another example, if the graphical element is not stored in memory 50, application 54 may produce a graphical element (e.g., guide lines 32b-d) by generating the graphical element.

At block 112, controller 44 produces display information based on the processed video information and the one or more graphical elements. For example, the display information may be used to cause one of the forms from the structure 131 to be displayed on driver or operator display interfaces 12, 18.

At block 114, controller 44 may provide the display information to one of the display screens 14, 20. For example, controller 44 may provide the display information to driver display screen 14 to cause driver display screen 14 to display driver form 67. In another example, controller 44 may provide the display information to operator display screen 20 that can cause operator display screen 20 to display the operator form 74a, 74b. The example process 100 then terminates.

Accordingly, the system and method described herein can improve the process of aligning hatches of equipment, such as vehicles, with a spout by providing real-time feedback to drivers and operators. The feedback is provided simultaneously on driver and operator display interfaces, and is controllable via the operator display interface. This is accomplished by the system automatically mirroring in real-time the operator display interface's feedback on the driver display interface without requiring separate configuration or initiation of the driver display interface. This improves the speed in which an operator can communicate with the driver, enhancing both operational efficiency and safety during the alignment process.

The process 100 shown in FIG. 11 may include one or more blocks in addition to and/or instead of the blocks shown in FIG. 11, and/or may include more than one of the blocks shown in FIG. 11. Further, many other methods to implement the system of FIGS. 1-10 may be used. The order of executing the blocks may be changed and/or one or more of the blocks may be changed, omitted, and/or performed in parallel. For example, the video information may be processed (block 104) and the graphical element(s) may be produced (block 108) by controller 44 in parallel.

As mentioned above, the process 100 of FIG. 11 may be implemented as computer-readable instructions that may be executed by controller 44. The computer-readable instructions may be included in software stored on one or more non-transitory computer-readable mediums associated with controller 44, such as memory 50, in which information is stored for any duration. Additionally or alternatively, the process 100 of FIG. 11 may be implemented as hardware that may perform the one or more blocks without executing software or firmware.

The computer-readable instructions may be downloaded to controller 44 from a software distribution platform (e.g., Apple App Store, Google Play Store, Microsoft Store). The computer-readable instructions may be stored in one or more formats such as, for example, an uncompressed format, a compressed format, an encrypted format, a fragmented format, a compiled format, an executable format, and/or a packaged format. For example, the computer-readable instructions may be fragmented and stored on one or more non-transitory computer-readable mediums located at the same or different locations of a network or collection of networks (e.g., in the cloud, in edge devices).

The computer-readable instructions may be one or more programs and/or one or more portions of programs for execution by one or more computing devices (e.g., controller 44). The computer-readable instructions may be in a non-executable state such that additional steps are required to make them executable by a computing device. Additional steps may include installation, modification, decryption, decompression, compilation, providing a library, configuration (e.g., settings stored), etc. Accordingly, the one or more non-transitory computer-readable mediums may include one or more machine-readable instructions regardless of the particular format, language, and/or or state of the machine-readable instructions.

Communications between elements are described herein using various terms such as, for example, “communicate”, “provide”, “obtain”, “receive”, etc. As used herein, communications can be direct communications and/or indirect communications through one or more intermediary elements.

As used herein, “real-time” means any latency or delays that are not readily perceptible to a human. For example, latency of not more than about 100 milliseconds between the start of movement of a vehicle within view of a camera, and the display of that movement on the screens displaying a video or image feed from that camera, would be considered “real-time”.

It should be understood that “including”, “comprising”, and “having” (and all other forms, such as tenses) are used herein to be open-ended terms. Thus, whenever a claim recites any form of “include”, “comprise”, or “have” (e.g., comprises, includes, has, comprising, including, having) as a preamble or within a claim recitation of any kind, it is to be understood that additional elements, terms, etc. may be present without falling outside the scope of the corresponding claim.

As used herein, singular references (e.g., “a”, “an”, “first”, “second”) do not exclude a plurality. The term “a” or “an” entity refers to one or more of that entity. The terms “a” (or “an”), “one or more”, and “at least one” can be used interchangeably. The term “and/or” when used in a form such as, for example, A, B, and/or C refers to any combination or subset of A, B, C such as (1) A alone, (2) B alone, (3) C alone, (4) A with B, (5) A with C, (6) B with C, and (7) A with B and with C.

Changes and modifications in the specifically described examples can be carried out without departing from the principles of the present disclosure which is intended to be limited only by the scope of the appended claims, as interpreted according to the principles of patent law including the doctrine of equivalents.

1. A system for alignment of a hatch of equipment with a spout in a loading bay area, the system comprising:
a memory; and
a controller coupled to the memory and configured to:
receive image feed information captured by a camera directed toward the spout,
generate a driver display interface on a driver display screen viewable by a driver of the equipment in the loading bay area;
generate an operator display interface on an operator display screen in a location remote from the driver display screen;
when controller receives a first input via the operator display interface:
provide on the driver display interface a first region including an image feed of the spout in real-time based on the image feed information, and
provide on the operator display interface: (i) a second region including the image feed of the spout in real-time based on the image feed information, the second region synchronous with the first region, and (ii) an input control manipulatable to provide a graphical element in the first and second regions; and
when the controller receives a second input via the input control of the display interface, provide on the first and second regions the graphical element in real-time.

2. The system of claim 1, wherein the controller is configured to receive the image feed information and provide the image feed on the driver and operator display interfaces without buffering.

3. The system of claim 1, wherein the controller is configured to operate on a first computing device associated with the operator display screen, and configured to:
simultaneously generate, by the first computing device, first and second display information;
render, by the first computing device, the first display information to provide on the operator display interface the second region and the input control; and
transmit, by the first computing device, the second display information to a second computing device associated with the driver display screen to provide the first region on the driver display interface.

4. The system of claim 3, wherein the controller is configured to create a one-way communication session between the first and second computing devices to transmit the second display information from the first computing device to the second computing device.

5. The system of claim 3, wherein the controller is configured to receive the image feed information in a compressed format, decompress the image feed information in the compressed format, and generate the first and second display information based on the image feed information in a decompressed format.

6. The system of claim 5, wherein the controller is configured to apply H.265 codec to decompress the image feed information in the compressed format.

7. The system of claim 1, wherein the graphical element comprises a guide line indicating a target position for the hatch and configured to be displayed over the image feed.

8. The system of claim 1, wherein the graphical element comprises a message for the driver of the equipment.

9. The system of claim 8, wherein the message indicates to the driver at least one of: (i) to maneuver the equipment to align the hatch with the spout, (ii) the hatch is aligned with the spout, (iii) loading of material from the spout to the hatch is to begin, and (iv) loading of material from the spout to the hatch has completed.

10. The system of claim 1, wherein the graphical element and the input control are respective ones of a first graphical element and a first input control, the controller configured to provide on the operator display interface the second region and the first input control without requiring user access credentials, and when the controller receives a third input via the operator display interface, the third input indicating user access credentials, the controller is configured to provide on the operator display interface a second input control manipulatable to provide a second graphical element in the first and second regions.

11. The system of claim 10, wherein the first input control is manipulatable to provide the first graphical element comprising a message in the first and second regions, and the second input control is manipulatable to provide the second graphical element displayed over the image feed in the first and second regions and indicating a target position for the hatch to be aligned with the spout.

12. A non-transitory computer readable medium storing instructions that, when executed by a controller, are configured to cause the controller to perform operations comprising:
receiving image feed information captured by a camera directed toward a spout;
generating a driver display interface on a driver display screen viewable by a driver of equipment in a loading bay area;
generating an operator display interface on an operator display screen in a location remote from the driver display screen;
when the controller receives a first input via the operator display interface:
providing on the driver display interface a first region including an image feed of the spout in real-time based on the image feed information, and
providing on the operator display interface: (i) a second region including the image feed of the spout in real-time based on the image feed information, the second region synchronous with the first region, and (ii) an input control manipulatable to provide a graphical element in the first and second regions; and
when the controller receives a second input via the input control of the operator display interface, providing on the first and second regions the graphical element in real-time.

13. The non-transitory computer readable medium of claim 12, wherein the receiving the image feed information and the providing the image feed on the driver and operator display interfaces is performed without buffering.

14. The non-transitory computer readable medium of claim 12, wherein the controller is configured to operate on a first computing device associated with the operator display screen, the operations further comprising simultaneously generating, by the first computing device, first and second display information, wherein the providing on the operator display interface the second region and the input control includes rendering, by the first computing device, the first display information, and the providing on the driver display interface the first region includes transmitting the second display information from the first computing device to a second computing device associated with the driver display screen.

15. The non-transitory computer readable medium of claim 14, the operations further comprising creating a one-way communication session between the first and second computing devices to transmit the second display information from the first computing device to the second computing device.

16. The non-transitory computer readable medium of claim 12, wherein the graphical element and the input control are respective ones of a first graphical element and a first input control, the operations further comprising providing on the operator display interface the second region and the input control without requiring user access credentials, and providing a second input control on the operator display interface in response to the controller receiving a third input indicating user access credentials via the operator display interface, the second input control manipulatable to provide a second graphical element in the first and second regions.

17. The non-transitory computer readable medium of claim 16, wherein the first graphical element is manipulatable to provide the first graphical element comprising a message in the first and second regions, and the second graphical element is manipulatable to provide the second graphical element displayed over the image feed and indicating a target position for a hatch of the equipment to be aligned with the spout.

18. A computer-implemented method comprising:
receiving image feed information captured by a camera directed toward a spout;
generating a driver display interface on a driver display screen viewable by a driver of equipment in a loading bay area;
generating an operator display interface on an operator display screen in a location remote from the driver display screen;
receiving a first input via the operator display interface;
in response to said receiving the first input:
providing on the driver display interface a first region including an image feed of the spout in real-time based on the image feed information, and
providing on the operator display interface: (i) a second region including the image feed of the spout in real-time based on the image feed information, the second region synchronous with the first region, and (ii) an input control manipulatable to provide a graphical element in the first and second regions;
receiving a second input via the operator display interface; and
in response to said receiving the second input, providing on the first and second regions the graphical element in real-time.

19. The computer-implemented method of claim 18, wherein said receiving the image feed information and said providing the image feed on the driver and operator display interfaces is performed without buffering.

20. The computer-implemented method of claim 18, further comprising simultaneously generating first and second display information on a first computing device associated with the operator display screen, wherein said providing on the operator display interface the region and the input control includes rendering the first display information, and wherein said providing on the driver display interface the region includes transmitting the second display information from the first computing device to a second computing device associated with the driver display screen.
